(19) United States
(12) Patent Application Publication
(10) Pub. No.: US 2026/0170068 A1
(43) Pub. Date: Jun. 18, 2026

(54) SYSTEMS AND METHODS FOR ENHANCED CONCEPT MAPPING WITH ASSOCIATED DIMENSION LAYERS FOR INTENT DETERMINATION

(71) Applicant: Inuvo, Inc, LIttle Rock, AR (US)

(72) Inventors: Amir Bakhshaie, Sunnyvale, CA (US); Hidayat Teonadi, Sunnyvale, CA (US); Arash Bahrami, Oakland, CA (US); Yuezhi Du, Milpitas, CA (US)

(73) Assignee: Inuvo, Inc, LIttle Rock, AR (US)

(21) Appl. No.: 18/978,171

(22) Filed: Dec. 12, 2024

(51) Int. Cl. G06F 16/9535; G06F 16/951

(52) U.S. Cl. CPC G06F 16/9535; G06F 16/951; G06N 3/045; G06N 7/046

(57) ABSTRACT

A computer network apparatus is configured to generate a plurality of concept profiles, where each concept profile includes at least one concept and at least one dimension layer associated with the concept. The concept profiles may be determined by crawling a plurality of nodes on a computer network and identifying concepts and context within the content of the nodes. The generated concept profiles are applied to provided client data to generate a client model associated with each client with content to deliver. The generated concept profiles are applied to content nodes for content placement within an inventory channel to generate inventory profiles associated with each content node in an inventory channel. The processor determines a correlation between an inventory profile and a client model and places client content on the content node of the inventory channel based on the determined correlation.

### FIELD OF THE INVENTION

The present invention relates to the field of computer science and content matching on computer networks. More particularly, the present invention relates to discovering relevant concepts, context, and dimensions for content on a computer network to determine a user's intent in consuming the content and using this information to provide targeted delivery of further relevant content.

### BACKGROUND OF THE DISCLOSURE

Information retrieval systems are typically designed to retrieve relevant content from a data repository, based on inputs from users. The user input can be in any of the following example forms: (i) a set of keywords, (ii) single or multiple lists of URL s and domains, and (iii) a set of documents (e.g., text files, HTML pages, or other types of markup language content). A goal of such information retrieval systems is to pull the most relevant content (i.e., most relevant to the given input) from the underlying repository, which might itself consist of a heterogeneous set of structured and unstructured content.

One example of such an information retrieval system is a traditional search engine, where a user provides a set of keywords, and the search engine provides simple ranked lists of top relevant web pages, and a separate list of top relevant paid listings or sponsored links. The set of web pages matching user's search queries and the advertisement database containing sponsored advertising materials are currently two separate databases that are processed very differently to pull the relevant pages and the sponsored links for the same user query. Thus, the conventional search engine described above provides an example of two distinct information repositories being processed in response to the same query.

Current systems attempt find important keywords of a web page then try to expand those keywords using various resources. This expanded set of keywords is compared with a user-provided set of keywords. One problem with such an approach is that keywords can have different meanings depending on context. For example, “Chihuahua” is a dog breed, but it is also a province in Mexico. In current systems, Chihuahua may expand to:
Chihuahua Breeders, Travel to
Chihuahua Travel to Mexico
Chihuahua Puppy Dog Training
Hotels in Chihuahua Teacup
Chihuahua Puppies Cheap flights,

A person interested in a Chihuahua dog would find information about the Chihuahua province or travel to it less useful. And a person interested in the Chihuahua province would find information about dog training or a Chihuahua dog less useful. Without knowing the context of the user-provided set of keywords, current systems often present search results that are irrelevant to what the user is seeking. To address these shortcomings, concept and context mapping have been applied, as described in applicant's U.S. patent application Ser. No. 17/968,750, entitled Discovering Relevant Concept and Context for Content Node, published on Feb. 9, 2023 as US2023-0043911, which is hereby incorporated by reference in its entirety.

In some cases, targeted advertising and delivery has focused on tracking the browsing history of individual users, such as by using cookies and tracking pixels. Using these tracking mechanisms, a detailed history of web sites visited and actions taken by a user can be compiled. From this compiled history, advertisers can then target advertisements perceived to be relevant to that specific user. For example, if a user's web browsing history shows searches related to new car models and visits to several websites for auto dealers, it may be inferred that the user is shopping for a car and advertisements related to car purchases may be provided, including car leasing deals, auto loans, auto insurance, and the like.

While a somewhat effective mechanism, such targeting requires detailed databases tracking each specific user's activity and, in some cases personal identifying information (“PI”) which raises significant privacy concerns and user backlash. In addition, such targeting may actually come too late, as the user's intent, i.e., purchasing a vehicle, may be discovered too late for the ads to be effective. In these cases, the targeting is reactive rather than predictive, reducing its efficacy.

It would be beneficial, therefore, to have a system which can evaluate user intent, i.e., why users are viewing certain content, rather than merely tracking who is viewing the content, to provide more effective ad targeting while still preserving user privacy. When the intent of consuming content is better understood, i.e., why are users consuming the content, it is possible to more effectively deliver relevant related content, such as advertising, without having to understand a specific individual user's browsing history.

While the aforementioned systems allow for limited targeting of advertisement and content, improvements in context analysis and mapping can provide expanded and more efficient targeted advertisement avenues. Accordingly, there is a need for an improved solution for advertisement targeting and improved context analysis.

### SUMMARY OF THE DISCLOSURE

In an exemplary embodiment, a computer network apparatus is configured to generate a plurality of concept profiles, where each concept profile includes at least one concept and at least one dimension layer associated with the concept. The concept profiles may be determined by crawling a plurality of nodes on a computer network and identifying concepts and context within the content of the nodes. The generated concept profiles are applied to provided client data to generate a client model associated with each client with content to deliver. The generated concept profiles are applied to content nodes for content placement within an inventory channel to generate inventory profiles associated with each content node in an inventory channel. The processor determines a correlation between an inventory profile and a client model and places client content on the content node of the inventory channel based on the determined correlation.

In some embodiments, the generating of concept profiles is performed by a generative AI tool using a large language model. In some embodiments, the dimension layers of the concept profiles may further comprise any of sentiment, audience size, audience age, geography, and time sensitive data.

In some embodiments, generating the inventory profile may further include generating a concept graph for each concept identified on each content node, and generating a dimension layer in the concept graph for each identified concept.

The present disclosure contemplates the computer network device, the methods of operating the device, and non-transitory computer readable media storing instructions for a processor to implement such systems and methods.

### BRIEF DESCRIPTION OF THE DRAWINGS

The accompanying drawings, which are incorporated into and constitute a part of this specification, illustrate one or more embodiments of the present invention and, together with the detailed description, describe the principles and implementations of the invention.

FIG. 1 is a simplified flow diagram that illustrates an exemplary method for generating concept profiles delivering relevant content, such as advertising, using client models and inventory models in accordance with the present disclosure;

FIG. 2 is a block diagram that illustrates a system for discovering relevant concepts and context for content nodes to generate a concept graph as used in accordance with one embodiment of the present systems and methods;

FIG. 3 is a schematic diagram that illustrates extracting candidate seed concepts from a document for generating a concept graph used in accordance with one embodiment of the present of the present systems and methods;

FIG. 4 is a block diagram that illustrates conceptual expansion of seed nodes onto a concept map in accordance with one embodiment of the present of the present systems and methods;

FIG. 5 is a block diagram that illustrates an example of a region of interest in concept space for a particular input page in accordance with one embodiment of the present of the present systems and methods;

FIG. 6 is a schematic diagram illustrating an enhanced concept graph in which identified concepts of a content node are further defined with one or more dimension layers, in accordance with the present systems and methods;

FIG. 7 is a schematic diagram illustrating an exemplary process of generating and updating a profile based on updated sentiment values aggregated from the web according to an exemplary embodiment of the present disclosure;

FIG. 8 is a flow diagram illustrating a method of using an enhanced audience model to match advertising to a content node in accordance with the present methods;

FIG. 9 is a schematic diagram that illustrates an example of matching pay per click (PPC) advertisements to web pages in accordance with one embodiment of the present invention; and

FIG. 10 is a block diagram illustrating an exemplary computer system suitable for practicing the present systems and methods.

### DETAILED DESCRIPTION

The present systems and methods are described in the context of evaluating content on a computer network, such as the internet, to discover relevant concepts and context for content consumed on the network to determine a user's intent, and using this information to provide targeted delivery of related and relevant content, such as advertising, to consumers of the content node. Those of ordinary skill in the art will appreciate that the following detailed description of the present systems and methods is illustrative only and the scope of the present invention is not intended to be limited to the disclosed embodiments. Other embodiments of the present systems and methods will readily suggest themselves to such skilled persons having the benefit of this disclosure. Reference will now be made in detail to the present implementations as illustrated in the accompanying drawings. The same reference indicators will be used throughout the drawings and the following detailed description to refer to the same or like parts.

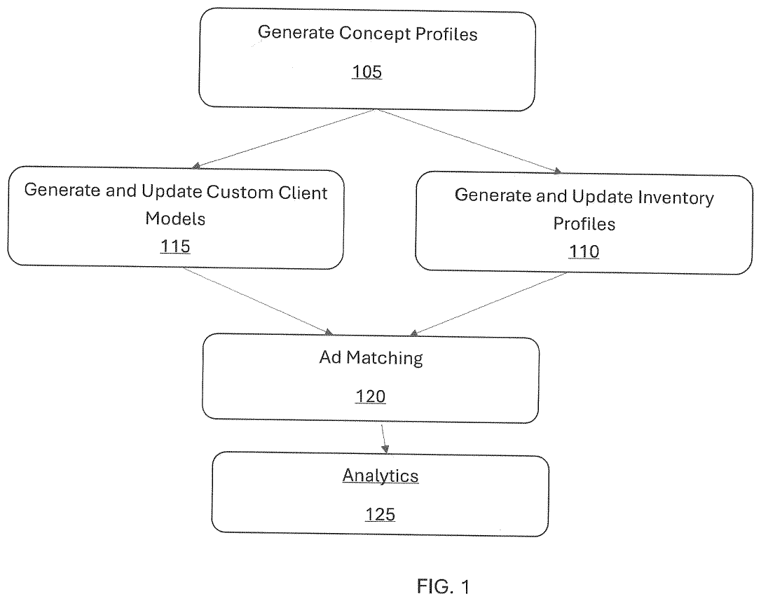

FIG. 1 is a simplified flow diagram illustrating an exemplary method for generating concept profiles delivering relevant content, such as advertising, using client models and inventory models in accordance with the present disclosure. In step 105, the method includes the step of generating concept profiles.

In the context of the present disclosure, the term “concept” refers to a unit of thought, expressed by a term, letter, or symbol. It may be the mental representation of beings or things, qualities, actions, locations, situations, or relations. A concept may also arise from a combination of other concepts. Example concepts include “diabetes,” “heart disease,” “socialism,” and “global warming.”

In the context of the present disclosure, the term “content node” refers to one or more groupings of data at a network location. Example groupings of data include various content on the internet, including, without limitation, a web page, a paid listing, a search query, video content, audio content, a text file, and the like.

In one preferred embodiment, concept profiles 105 may be generated using a generative AI tool which is based on a large language AI model deployed to crawl the web, analyze various sources of media and their relationships, and to extract concept profiles. The use of generative AI may provide for richer concept profiles with more complex context developed for the concepts than those derived by algorithmically identifying keywords and related terms in the content.

In some embodiments, the idea of user sentiment, discussed more fully below, can be analyzed and used to further refine the concept profiles 105. By applying a large language model across a broad range of content available on a network, such as the internet, rich concept profiles 105 can be efficiently generated and regularly updated and used to evaluate not only subject matter of content of a specific content node but various aspects of user intent when consuming such content.

The concept profiles 105 can be used to generate inventory profiles 110 and custom client models 115. Inventory profiles 110 are models which characterize the content nodes of various channels available for content distribution, including web pages, video and television content, podcasts, social media and the like. Like the concept profiles, the inventory profiles 110 may include indications of user sentiment. Preferably, the inventory profiles 110 are updated periodically, and preferably relatively often, such as in minutes. In one embodiment, inventory profiles are updated as quickly as every five minutes, which provides for monitoring and responding to changes in trends in a near realtime fashion. For example, changes in sentiment of a particular concept within a channel may be detected and influence content placement. As an example, news of a significant automotive recall could result in user sentiment for the affected brand going from positive to negative, which may be reflected in the updated inventory profiles as changes in user behavior interacting with various content within the inventory channel is detected.

Custom client models 115 can be updated periodically, such as daily, to reflect current trends identified in the inventory profiles. Client models are generated using metrics about the client, such as by analyzing advertising content to be placed and keywords of interest to the client using the concept profiles 105 to identify and expand concepts relevant to the client.

The inventory profiles 110 and client models 115 are used to match client content to distribution inventory in ad matching step 120. By applying the robust client models 115 and inventory profiles 110, content that is highly relevant can be delivered without reliance on tracking the identity or specific behavior of particular users, thereby providing effective delivery of content without compromising privacy of the users. In the case of advertising content, this can provide highly effective ad delivery with increased conversion and return on investment (ROI) for ad spend without the use of tracking cookies or tracking pixels which inherently compromise privacy.

Analytics engine 125 evaluates the performance of content placement, such as clickthrough rates, conversions on advertising, and the like, and provides a graphical user interface (GUI) which allows advertisers to quickly evaluate the efficacy of the placements and campaigns.

The present systems and methods examine content of interest to a user, to determine what concepts are most closely associated with that content. Other content that is closely associated with the same concepts taken in context is more likely be of interest to the user. And other content which may have similar words may relate to different concepts and are less likely to be of interest to the user. The present systems and methods use concept information previously gleaned from an analysis of other web pages to better understand the context of a current web page. This analysis can be performed algorithmically, or preferably, using a generative AI tool to generate concept models 105.

Concepts extracted from the current web page that are not related to the current context may be pruned. The content known to be of interest to the user may be presented along with other content that is closely associated with the concepts related to the current context, thus increasing the likelihood that the user will find the other content interesting.

For example, suppose a user visits a web page describing the “Chihuahua” province of Mexico. The “Chihuahua” may expand to:
Chihuahua Breeders,
Travel to Chihuahua
Travel to Mexico
Chihuahua Puppy Dog Training
Hotels in Chihuahua
Teacup Chihuahua Puppies Cheap
flights

But the current context relates to the “Chihuahua” province, not the Chihuahua dog breed. Concepts extracted from the current web page that are not related to the current context are preferably pruned, resulting in only concepts related to the current context: Travel to Chihuahua, Travel to Mexico, Hotels in Chihuahua, Cheap flights. This information for each content node can be maintained in the inventory profiles 110. Ad matching 120 correlates characteristics of the custom client models 115 to those of the inventory profiles 110, such that the current web page may be presented along with other content (e.g. paid listings or other websites) that is closely associated with these four remaining concepts that are related to the current context, thus increasing the likelihood that the user will find the other content interesting.

In the context of the present embodiments, the term “concept association map” refers to a representation of concepts, concept metadata, and relationships between concepts.

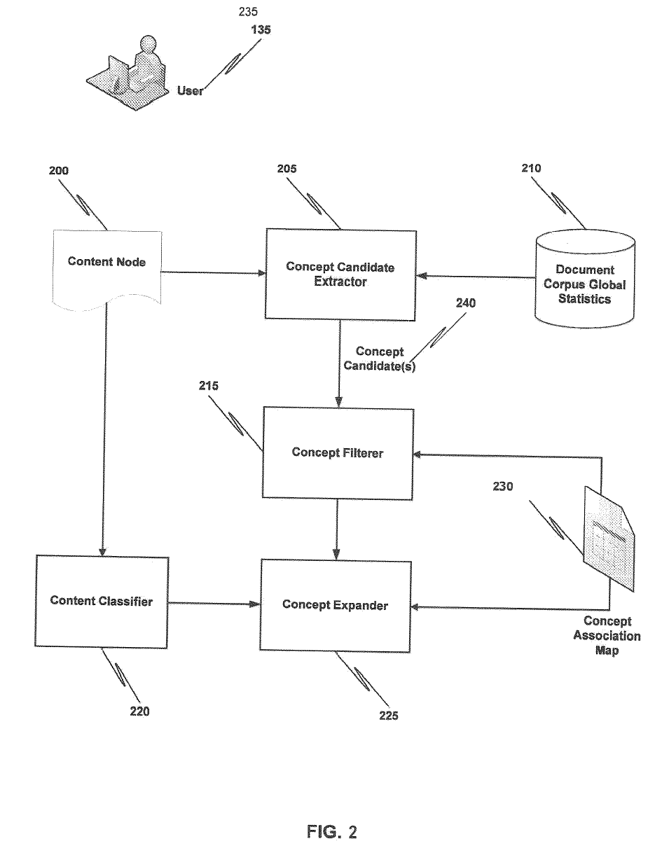

FIG. 2 is a block diagram that illustrates one exemplary system for discovering relevant concepts and context for content nodes in accordance with one embodiment. As shown in FIG. 2, concept association map 230 includes concepts and their relationships, which may be expressed as bi-directional edges. Concepts are nodes in a graph, and different kinds of meta-data are associated with each such node. For example, the node meta-data can include the frequency of appearance of the concept in a given corpus, its structural relevance in the graph, cost per action (CPA) and click through rate (CTR) data for ads associated with it, CTR data for the concept itself as derived from user 235 browsing patterns, as well as a labeling that associates it with a specific category. Unlike static concept databases, this concept association map 130 is dynamic and it is continuously updated by the system.

According to one embodiment of the present invention, the concept association map 230 is derived from different sources. Example sources include concept relationships found on the World Wide Web, associations derived from users 235 browsing history, advertisers bidding campaigns, taxonomies, and encyclopedias.

Still referring to FIG. 2, concept candidate extractor 205 is configured to identify one or more relevant concept candidates in a content node 200. Concept candidate extractor 205 relies at least in part on a set of statistical measures (document corpus global statistics 210) in order to identify such candidates. According to one embodiment of the present invention, one or more of the following statistical measures 210 are used to extract concept candidates:
a. Global document frequency of n-grams defining a concept. This measure is indicative of the likelihood that a given n-gram will appear in a document that is part of a corpus.
b. Frequency of n-grams in the content node 200.
c. Similarity of the content node 200 to other content nodes for which relevant concept candidates have already been identified.
d. Weight of the node in the concept graph.

According to one exemplary embodiment, concept candidates 240 are extracted from different input sources associated with a page on a network, such as the World Wide Web, viz. the body of the HTML page, the title, the meta-data tags, the anchor text of hyperlinks pointing to this page, the anchor text of hyperlinks contained in the page, the publishing history of the page, as well as the same type of input sources for pages related to this one.

According to one embodiment, the content to be tagged with concepts is provided directly by the user 235, for example in the form of a text file.

According to one embodiment, the content to be tagged is any textual section of a relational database, e.g. a product inventory database.

According to another embodiment of the present invention, the node content is a user query, defined as a set of search keywords.

According to another embodiment, the concept candidates 140 are provided by the user 235 as input to the system. For example, in a bidding campaign a content provider or a merchant could provide such a list based on internal knowledge about the products to be advertised.

According to one embodiment, for web page, top referral queries on major search engines are also identified as top concepts. For example, if for a URL a.b.com/d, most of the incoming traffic from major search engines is coming from users 235 searching for query “diabetes” and “diabetes symptoms,” these queries are added as top concepts.

According to another embodiment, concepts can also get identified from other pages relevant to the page of interest, for example if the relevant page is structurally similar (through hyperlinks) to the page of interest, or if the relevant page is contextually similar (same content) to the page of interest.

Concept candidate extractor 205 is configured to use the aforementioned statistics to extract suitable concept candidates in the content node 200. This is accomplished by matching the concepts available in the concept association map 230 against the text in the content node 200.

Concept filterer 215 is configured to rank the concept candidates 240 based at least in part on a measure of relevance that weighs their frequency in the content node 200, their likelihood of appearing in a document, as well as the likelihood of being selected based on the closeness of this content node 200 to similar concept nodes.

According to another embodiment, for the case of structured content (e.g. a web page), different content sections are weighed according to their relative importance. For example, the title of a page is weighted more than the body of the page, relative to its length.

While FIG. 2 provides a structural block diagram illustrating an algorithmic approach to discovering relevant concepts and context for content nodes, it will be appreciated that this process can be performed using a trained generative AI tool based on a large language model. It will be further appreciated that in one exemplary embodiment, an algorithm as described in FIG. 2 can generate sets of data comprising content and concept maps to train a generative AI to generate such content association maps.

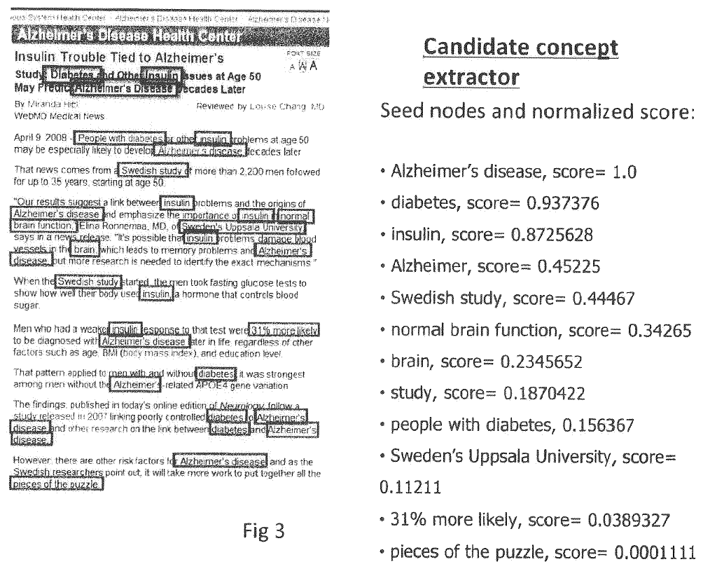

FIG. 3 is a schematic diagram that illustrates extracting candidate seed concepts from a document in accordance with one embodiment. As shown in FIG. 3, node content is: [type=web page, url=http://www.webmd.com/alzheimers/news/20080409/insulin-trouble-tied-to-alzheimers] The concept candidates selected and their respective scores are, ranked in order of decreasing relevance:

[insulin, score = 1.0]
[diabetes, score = 1.0]
[people with diabetes, score = 0.873529]
[Swedish study, score = 0.123344]
[Alzheimer's disease, score = 0.3456]
[study, score = 0.43222]
[brain, score = 0.986292]
[normal brain function, score = 0.563738]
[more research is needed, score = 0.23445]
[Sweden's Uppsala University,
score = 0.432122] [released in 2007, score = 0.13456]
[31% more likely to be diagnosed, score = 0.11111]
[pieces of the puzzle, score = 0.0045466]

The mapping of the candidates against the available conceptual map shows that the following concept candidates are associated with high score relative to other concept candidates: [diabetes, people with diabetes, Alzheimer's disease, brain, normal brain function, insulin].

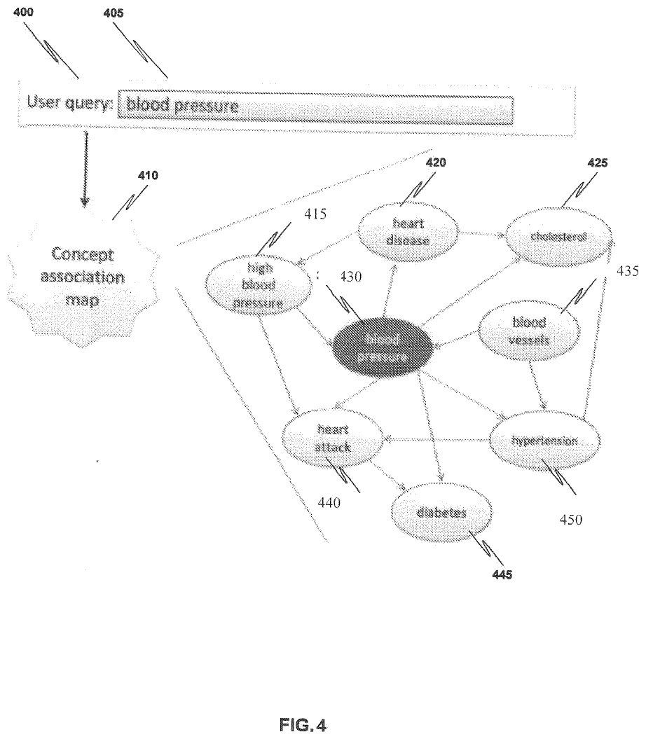

Referring again to FIG. 2, concept expander 225 is configured to expand the initial set of seed concepts by selecting neighbors of such seed nodes, according to a set of cost functions. This is described in more detail below with reference to FIG. 4.

FIG. 4 is a block diagram that illustrates conceptual expansion of seed nodes onto a concept map in accordance with one embodiment of the present invention. In FIG. 4, the user has entered “blood pressure.” “Blood pressure” is found in concept association map 410 and is thus a seed concept. As shown in the blown-up portion of concept association map 410, the neighbors of the “blood pressure” concept 430 are “high blood pressure” 415, “heart disease” 420, “cholesterol” 425, “blood vessels” 435, “hypertension” 450, “diabetes” 445, and “heart attack” 440.

One cost function is based on selecting the neighbors that present the best clustering characteristics, i.e. they are more likely to be strongly associated with each other. Another cost function is based on selecting neighbors that, based on aggregate user activity history, have a higher likelihood to be associated. Yet another cost function is based on looking at the likelihood that such concepts are selected together based on their co-occurrence in a corpus of documents (e.g. the World Wide Web). A further cost function can be based on determining which neighboring concepts in the concept association map are tied to a form of monetization (e.g. online advertisement) that yields the highest conversion rate (measured as a combination of CPC and CTR).

According to one embodiment, the nodes in the concept association map may be tagged with labels representing one or more high-level categories. Referring to FIG. 2, according to one embodiment, a page content classifier 220 may be utilized to label the page with a high-level category in order to narrow down the mapping to the concept association map 230 to certain pre-defined contexts. According to a further embodiment, results on the concept association map 230 are clustered to identify different user's intention.

According to yet another embodiment, the highest-weighted concepts in the graph are chosen as top related concepts. Weight score can be defined using different sources. Examples of weights to be used are structural scores like “betweenness” and “page rank,” monetization values like click through and cost per click and frequency of appearance on the web or user's query logs.

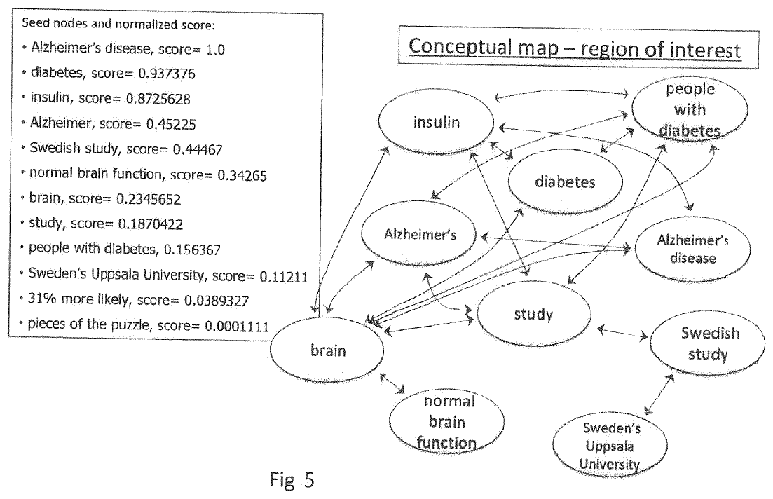

FIG. 5 is a block diagram that illustrates an example of a region of interest in concept space for a particular input page. The concept association map can be augmented by adding links between search queries and concepts on the concept association map through the pages that received these referrals. For example, if page a.b.c.com/d receives a large volume of search traffic for the term “diabetes diagnostic” and the page is mapped to region of interest with top concepts: “diabetes disease,” “diabetes symptoms,” and “type 2 diabetes,” the weight of the link between these concepts and “diabetes diagnostic” can be increased.

It will be appreciated that the concept and context analysis illustrated in FIGS. 3-5 are examples of textual analysis and that such tasks are well suited for an appropriately trained generative AI tool.

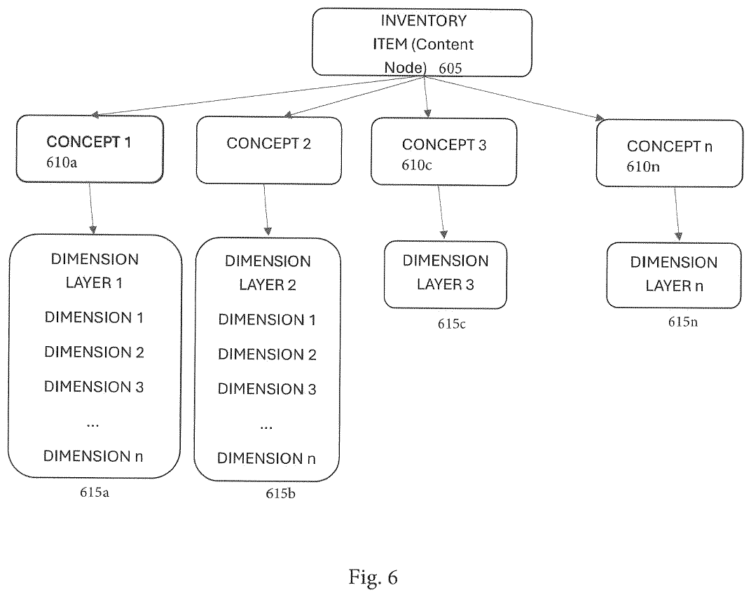

The concept map is a useful tool for associating content nodes with identified concepts thereby allowing more efficient targeting of advertising. This can be further refined, however, by further analysis and abstraction of each identified concept with an additional dimension component. FIG. 6 illustrates an enhanced concept map where each content node 605 has a plurality of identified concepts 610a-n, extracted as described above in connection with FIGS. 1-5. Each concept 610a-n has an associated dimension layer 615a-n which includes one or more dimensions, each of which providing a further measure of demographic insight related to the concept 610. Examples of dimensions may include: “sentiment” which is a measure of audience reaction to the concept (e.g., favorable v. unfavorable), audience size, audience age, geography, time sensitive data (e.g., trending data), and the like.

As another example, the crawling process may identify a sentiment (e.g., positive, negative, neutral, etc.) towards the content node 605 and its concepts 610a-n based on additional keywords or context. The concepts for the content node and the sentiment of the content node may be stored for that node in the inventory profile 110. For example, a sentiment value may include “positive,” “negative,” and “neutral,” however other sentiment values may be provided. The sentiment values may be determined using a machine learning model. The machine learning model may take content from the page as input, and output a sentiment of the page, such as positive, negative, or neutral. The sentiment may be determined based on keywords, patterns, and the like, within the textual content on the page or relationships to other content nodes.

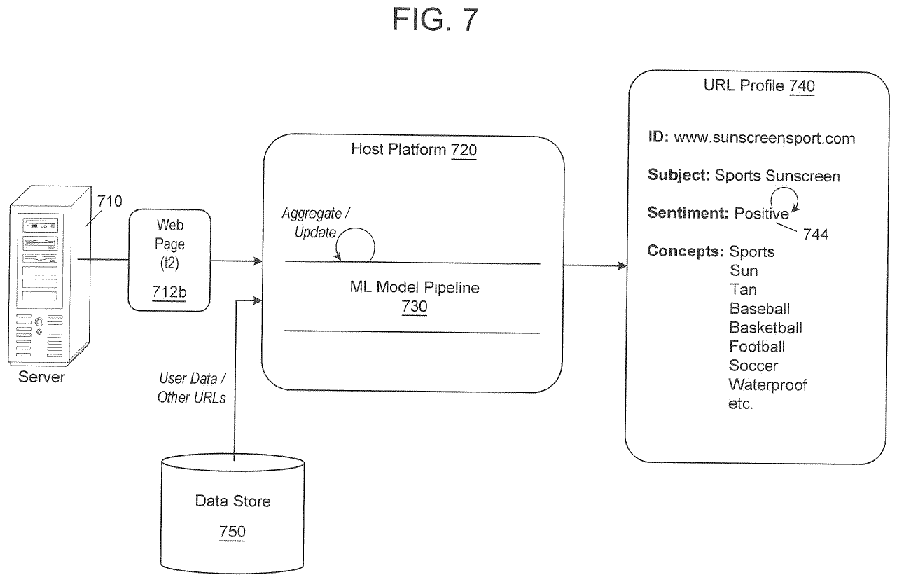

FIG. 7 illustrates a process of crawling the web for web pages and identifying sentiment values associated therewith according to an example embodiment. In these examples, a server 710 may crawl the Internet for all pages that have been accessed that day, or other period of time. The server 710 may build a profile for each new page that it encounters as shown in the process of FIG. 7. For pages with existing profiles, the server 710 may update the profile after each crawl with new sentiment data/updates.

Referring to FIG. 7, the server 710 may encounter a new web page 712 during a first crawl process at a first time, for example, a first day. In response to detecting the new web page 712, the server 710 may forward the new web page 712 to a host platform 720 which includes a machine learning service that may include a model pipeline 730 that includes a plurality of machine learning models/artificial intelligence models that are configured to identify attributes of the new web page 712. As just one example, a model within the model pipeline 730 may receive, as input, the content from the new web page 712 and output a sentiment value such as “neutral,” “negative,” “positive,” or other like indicator of user sentiment, based on predefined negative and positive keywords, word patterns, and a combination thereof. It should also be appreciated that the sentiment value may be determined based on multiple different data inputs including the sentiment of neighboring pages/URLs, the sentiment of users that visit the pages, etc.

The sentiment can be embedded as a sentiment value 742 in the URL profile 740. Other data may also be added to the URL profile 740 including concepts that are identified on the new web page 712, a subject of the new web page 712, a URL or identifier of the new web page 712, or the like.

The example in FIG. 7 is described in the context of “web pages” but it will be appreciated that these methods can be used in various channels to evaluate any content, including video, audio, social media posting, and the like.

The concepts, neighbor concepts, and dimensions can be identified using a trained generative large language model in conjunction with a web crawler to identify patterns and trends not only in the content. Using a generative AI model to better understand why content is consumed by visitors provides a tool for placing advertisements to new audiences with similar concepts.

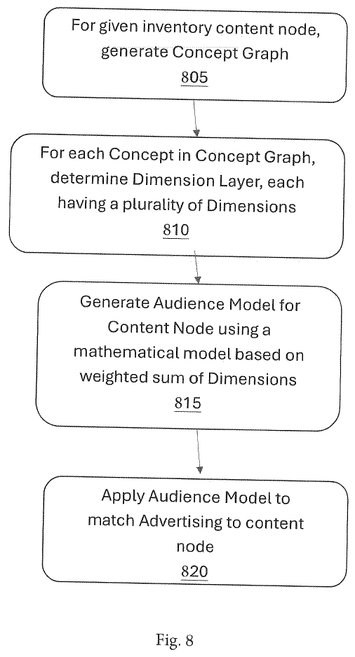

The enhanced content map can then be used to generate inventory profiles 110, as illustrated in the flow diagram of FIG. 8. In step 805, a concept graph is generated for a particular inventory content node 605, as described above. In step 810, for each identified concept 610a-n, an associated dimension layer 615a-n is generated, with each dimension layer preferably having one or more dimensions associated with each concept, as described in connection with FIG. 6. In step 815, a mathematical model is applied to generate a weighted sum of the dimensions in the associated dimension layers to generate an audience model for the inventory content node 605. In step 820, the audience model is then applied to match advertising to the inventory content node 605.

One example of an inventory profile being those for full URLs. The particular content nodes are determined by either directly finding them present on the URL, not directly present but inferred by the relationship of concepts on the page, and/or inferred to be important by analyzing visitors on the URL. In some embodiments, the inventory profiles are a mathematical model derived from a weighted sum of the dimensions for each concept. The specific weights applied to the dimensions may be manually adjusted to optimize the results. The inventory profiles provide a predictive model of the typical audience member visiting the URL.

Various weights can be applied to the raw score of concepts, such as On Page Concepts, Visitor Concepts, and not on page or Off Page Concepts. The weighted concepts can be applied and ranked together. For example, On Page Concepts can be weighted as 0.6, Visitor Concepts can be weighted as 0.30, and Off Page Concepts can be weighted as 0.10. It will be appreciated that these weights are exemplary, and any other appropriate weights may be applied depending on concepts to be emphasized for a specific model or application. In this example if On Page Concept 1 had a raw score of 200, its weighted score would be 120. Similarly, Visitor Concept 5 with a raw score of 300, would have a weighted score of 100, On Page Concept 2 with a raw score of 100 would have a weighted score of 60, and Off Page Concept 3 with a raw score of 400 would have a weighted score of 40.

Significantly, inventory profiles, which are based on visitor behavior and content relationships rather than visitor identity, provide a robust model providing strong predictive value of visitor intent without focusing on the specific user's identity, which allows targeted advertising without the need for cookies, specific user browser history, or other personal identifying information of a visitor. Thus, the present disclosure provides a robust advertising placement model which yields high ROI while still being privacy compliant.

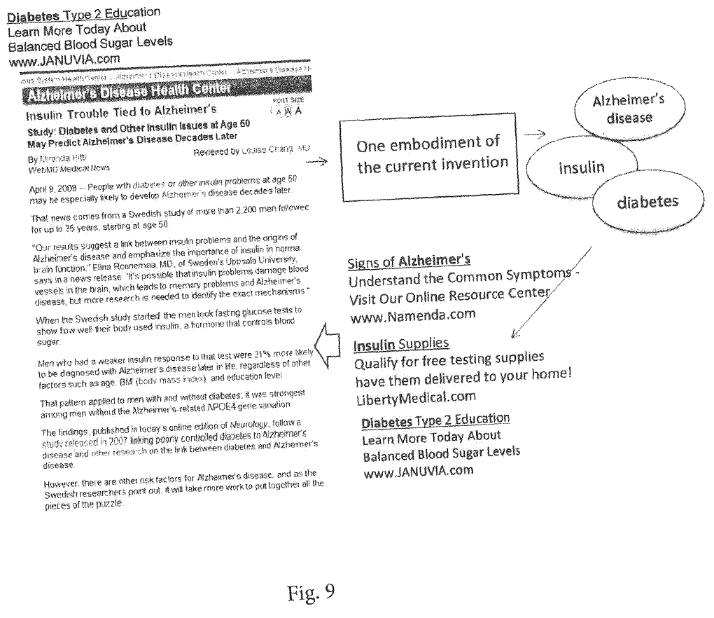

Top concepts and regions of interest can be used to map paid listings or other forms of advertisement to the content node as described in FIG. 9. FIG. 9 is a schematic diagram that illustrates matching pay per click (PPC) advertisements to web pages in accordance with one embodiment of the present invention. In FIG. 9, a web page displaying a document entitled “Insulin Trouble Tied to Alzheimer's” is shown on the left, and three paid listings are shown on the right. The document and the paid listings are considered content nodes. The top concepts identified in the document are “Alzheimer's disease,” “insulin,” and “diabetes.” The particular, three paid listings are selected based on how closely the listings are identified with the same top concepts identified in the document. The paid listing “Signs of Alzheimer's” is identified with the concept “Alzheimer's disease.” The paid listing “Insulin Supplies” is identified with the concept “insulin.” The paid listing “Diabetes Type 2 Education” is identified with the concept “diabetes.” The effectiveness of the paid listings is increased by placing the listings near the document identified with the same concepts.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

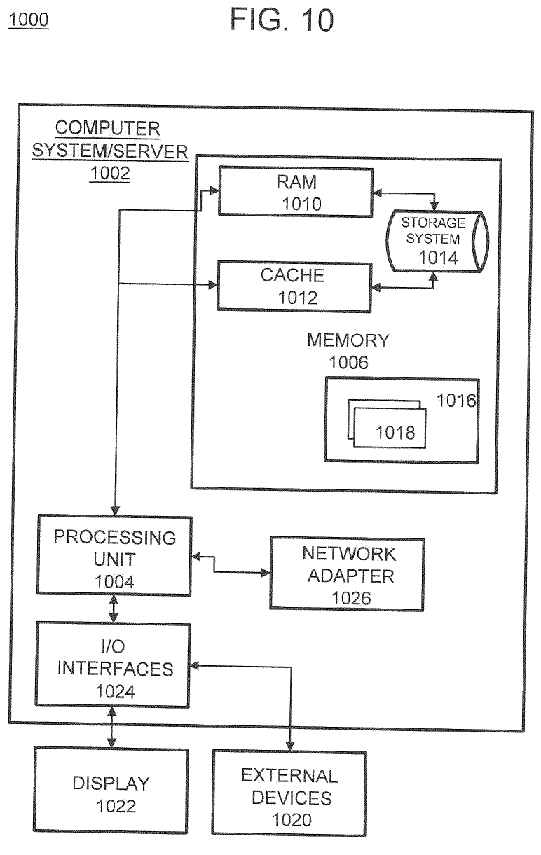

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 10 illustrates an example computer system architecture, which may represent or be integrated in any of the above-described components, etc.

FIG. 10 illustrates an example system 1000 that supports one or more of the example embodiments described and/or depicted herein. The system 1000 comprises a computer system/server 1002, which is operational with numerous other general purpose or special purpose computing system environments or configurations. Examples of well-known computing systems, environments, and/or configurations that may be suitable for use with computer system/server 1002 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1002 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1002 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 10, computer system/server 1002 in cloud computing node 1000 is shown in the form of a general-purpose computing device. The components of computer system/server 1002 may include, but are not limited to, one or more processors or processing units 1004, a system memory 1006, and a bus that couples various system components including system memory 1006 to processor 1004.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1002 typically includes a variety of computer system readable media. Such media may be any available media that is accessible by computer system/server 1002, and it includes both volatile and non-volatile media, removable and non-removable media. System memory 1006, in one embodiment, implements the flow diagrams of the other figures. The system memory 1006 can include computer system readable media in the form of volatile memory, such as random-access memory (RAM) 1010 and/or cache memory 1012. Computer system/server 1002 may further include other removable/non-removable, volatile/non-volatile computer system storage media. By way of example only, storage system 1014 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 1006 may include at least one program product having a set (e.g., at least one) of program modules that are configured to carry out the functions of various embodiments of the application.

Program/utility 1016, having a set (at least one) of program modules 1018, may be stored in memory 1006 by way of example, and not limitation, as well as an operating system, one or more application programs, other program modules, and program data. Each of the operating system, one or more application programs, other program modules, and program data or some combination thereof, may include an implementation of a networking environment. Program modules 1018 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present application may take the form of a computer program product embodied in one or more computer readable medium(s) having computer readable program code embodied thereon.

Computer system/server 1002 may also communicate with one or more external devices 1020 such as a keyboard, a pointing device, a display 1022, etc.; one or more devices that enable a user to interact with computer system/server 1002; and/or any devices (e.g., network card, modem, etc.) that enable computer system/server 1002 to communicate with one or more other computing devices. Such communication can occur via I/O interfaces 1024. Still yet, computer system/server 1002 can communicate with one or more networks such as a local area network (LAN), a general wide area network (WAN), and/or a public network (e.g., the Internet) via network adapter 1026. As depicted, network adapter 1026 communicates with the other components of computer system/server 1002 via a bus. It should be understood that although not shown, other hardware and/or software components could be used in conjunction with computer system/server 1002. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A method for delivering content on a computer network comprising:
generating a plurality of concept profiles, each concept profile being a first data structure including at least one concept and at least one dimension layer associated with the concept, wherein the concept profiles are determined by a web crawling server crawling a plurality of content nodes on a computer network and identifying concepts and context within the content of the content nodes;
receiving client data for deliverable content;
applying the concept profiles generated by the web crawling server to the provided client data to generate a client model, the client model being a second data structure associated with each client with deliverable content;
applying the generated concept profiles to content placement nodes within an inventory channel to generate inventory profiles, each inventory profile being a third data structure associated with each content placement node in the inventory channel, wherein each inventory profile includes a concept graph for each concept identified on each content node and a dimension layer in the concept graph for each identified concept;
determining a correlation between at least one of the inventory profiles and a client model; and
placing client deliverable content on a selected content placement node of the inventory channel based on the determined correlation.

2. The method of claim 1, wherein the generating of concept profiles is performed by a generative AI tool using a large language model.

3. The method of claim 1, wherein the at least one dimension layer of the concept profiles further comprises at least one of sentiment, audience size, audience age, geography, and time sensitive data.

4. (canceled)

5. A computer network apparatus comprising:
a memory; and
a processor coupled to the memory and configured to:
generate a plurality of concept profiles, each concept profile being a first data structure including at least one concept and at least one dimension layer associated with the concept, wherein the concept profiles are determined by a web crawling server crawling a plurality of content nodes on a computer network and identifying concepts and context within the content of the content nodes;
receive client data for deliverable content;
apply the concept profiles generated by the web crawling server to the provided client data to generate a client model, the client model being a second data structure associated with each client with deliverable content;
apply the generated concept profiles to content placement nodes within an inventory channel to generate inventory profiles each inventory profile being a third data structure associated with each content placement node in the inventory channel, wherein each inventory profile includes a concept graph for each concept identified on each content node and a dimension layer in the concept graph for each identified concept;
determine a correlation between at least one of the inventory profiles and a client model; and
place client deliverable content on a selected content placement node of the inventory channel based on the determined correlation.

6. The computer network apparatus of claim 5, wherein the generating of concept profiles is performed by a generative AI tool using a large language model.

7. The computer network apparatus of claim 5, wherein the at least one dimension layer of the concept profiles further comprises at least one of sentiment, audience size, audience age, geography, and time sensitive data.

8. The computer network apparatus of claim 5, wherein generating the inventory profile further includes generating a concept graph for each concept identified on each content node, and the method further comprises generating a dimension layer in the concept graph for each identified concept.

9. A non-transitory computer readable media storing instructions for a computer process for delivering content on a computer network comprising:
generating a plurality of concept profiles, each concept profile being a first data structure including at least one concept and at least one dimension layer associated with the concept, wherein the concept profiles are determined by a web crawling server crawling a plurality of content nodes on a computer network and identifying concepts and context within the content of the content nodes;
receiving client data for deliverable content;
applying the concept profiles generated by the web crawling server to the provided client data to generate a client model, the client model being a second data structure associated with each client with deliverable content;
applying the generated concept profiles to content placement nodes within an inventory channel to generate inventory profiles, each inventory profile being a third data structure associated with each content placement node in the inventory channel, wherein each inventory profile includes a concept graph for each concept identified on each content node and a dimension layer in the concept graph for each identified concept;
determining a correlation between at least one of the inventory profiles and a client model; and
placing client deliverable content on a selected content placement node of the inventory channel based on the determined correlation.

10. The non-transitory computer readable media of claim 9, wherein the generating of concept profiles is performed by a generative AI tool using a large language model.

11. The non-transitory computer readable media of claim 9, wherein the at least one dimension layer of the concept profiles further comprises at least one of sentiment, audience size, audience age, geography, and time sensitive data.

12. The non-transitory computer readable media of claim 9, wherein generating the inventory profile further includes generating a concept graph for each concept identified on each content node, and the method further comprises generating a dimension layer in the concept graph for each identified concept.

13. The method of claim 1, wherein the deliverable content is an advertisement.

14. The computer network device of claim 5, wherein the deliverable content is an advertisement.

15. The non-transitory computer readable media of claim 9, wherein the deliverable content is an advertisement.
